(19) United States
(12) Patent Application Publication
(10) Pub. No.: US 2022/0379800 A1
(43) Pub. Date: Dec. 1, 2022

(54) AUXILIARY VEHICLE LED LIGHTING SYSTEM AND METHOD OF USE

(71) Applicant: Eugene G. Walasik, Ocala, FL (US)

(72) Inventor: Eugene G. Walasik, Ocala, FL (US)

(21) Appl. No.: 17/878,879

(22) Filed: Aug. 1, 2022

Related U.S. Application Data
(63) Continuation-in-part of application No. 15/604,186, filed on May 24, 2017.
(60) Provisional application No. 62/340,594, filed on May 24, 2016.

(51) Int. Cl. B60Q 1/00; B60Q 1/30; B60Q 1/32; B60Q 1/46; B60Q 1/26; F21S 43/14; F21S 43/15; F21V 23/04

(52) U.S. Cl. CPC B60Q 1/0088; B60Q 1/30; B60Q 1/32; B60Q 1/46; B60Q 1/2615; F21S 43/14; F21S 43/15; F21V 23/0435; F21Y 2103/10

(57) ABSTRACT

The present invention is an LED lighting system which can be retrofit to an existing vehicle. The lighting system can provide sequential lighting of multiple lamps for effect. In a non-limiting embodiment, a 7-pin wireless remote controller may be plugged directly into a vehicle's 7-pin hitch harness port where it draws power and receives light signals for stopping, hazard (four-way lights), turning. It then in turn will process and communicate these signals to a wireless LED strip. In another non-limiting embodiment, a 4-pin wireless remote controller may be connected directly to a vehicle's 4-pin harness plug, if equipped, or spliced directly into the vehicle's wire harness if it is not equipped with a 4-pin plug. The 4-pin wireless remote controller will process these light signals and communicate them to a wireless LED strip.

### CROSS-REFERENCE TO RELATED APPLICATIONS

The present application is a continuation-in-part application of and claims the priority benefit of U.S. Nonprovisional Patent Application Serial No. 15/604,186, filed on May 24, 2017, which claims the priority benefit of U.S. Provisional Patent Application Serial No. 62/340,594 filed on May 24, 2016, which are both incorporated herein by reference in their entireties.

### BACKGROUND OF THE INVENTION

The present invention generally relates to vehicle lighting systems. More specifically, the present invention is an LED lighting system which can be retrofit to an existing vehicle.

Failure to see and respond to vehicle stop and turn lights are the main reasons for rear end vehicle accidents. Drivers are unable to clearly see the signals or are not aware of the signals.

Brighter and more visible lights make vehicles safer to operate because they attract better attention from other drivers. Vehicle lighting can also play an artistic role in allowing the vehicle to be customized to the tastes or specific needs of the owner. In the United States, three brake lights are now mandatory on all vehicles.

Historically, vehicle lighting has been incandescent bulbs powered by the vehicles 12v electrical system. In such instances, the lighting system consists of a source of power, wiring to convey the power, a bulb and a switch to turn the bulb on and off. Typically, switches are used to operate tail lights, brake lights, back up lights and turn signal lights. Retrofitting incandescent bulbs is as simple as tapping into the existing wiring harness.

Incandescent vehicle lights have been made to be sequential by the use of time delay circuits such as conventional resistor and capacitors wired in series between individual lamps. In this manner, turn signals or brake lights having multiple bulbs have been made to start with one lamp and sequentially light up other lamps as the capacitor charge and pass current to the next lamp. A person of moderate skill could tap into a vehicle wiring harness and add a time delay circuit between individual bulbs on the circuit.

More recently, vehicle lighting is increasingly LED based. LED lights are mounted on circuit boards which contain at least one LED lamp but frequently contain arrays of LED lamps to provide increased brightness and redundancy in the event a lamp burns out. LED lamps typically have a single power connection to the circuit board which then feeds the lamp array. These systems are not customizable because the lamps are circuit board mounted with the current carried through the circuit board. As such, the power connections to each lamp are not accessible.

There is a need in the art of a means to customize vehicle lighting systems to allow the addition of additional lights or to control the operation of individual lamps. Such a system would allow for creating light displays ranging from simple sequential lighting to full motion. The motion would better catch the attention of other drivers. The display is limited primarily by the number of LED bulbs used.

### SUMMARY OF THE INVENTION

The present invention is an LED lighting system which can be retrofit to an existing vehicle. Vehicle brake lights and tail lights are generally all on or all off with the lamps of the tail lights and the brake lights controlled by a single on-off switch. As built by the manufacturer, these lights are not customizable by the user or capable of being lit at different times or in patterns. The lighting system can provide sequential lighting of multiple lamps for effect. By sequential, one lamp or group of lamps will light first, a second group of lamps will light and so on to achieve the desired effect.

In a non-limiting embodiment, a 7-pin wireless remote controller may be plugged directly into a vehicle's 7-pin hitch harness port where it draws power and receives light signals for stopping, hazard (four-way lights), turning. It then in turn will process and communicate these signals to a wireless LED strip.

In another non-limiting embodiment, a 4-pin wireless remote controller may be connected directly to a vehicle's 4-pin harness plug, if equipped, or spliced directly into the vehicle's wire harness if it is not equipped with a 4-pin plug. The 4-pin wireless remote controller will process these light signals and communicate them to a wireless LED strip.

### BRIEF DESCRIPTION OF THE DRAWINGS

FIG. 1 is a wiring diagram for lights of the present invention;

FIG. 2 is an environmental view of an embodiment of a vehicle lighting system of the present invention, mounted on a spoiler;

FIG. 3 is an environmental view of an embodiment of a vehicle lighting system of the present invention, mounted inside the rear window of a car;

FIG. 4 is an environmental view of an embodiment of a vehicle lighting system of the present invention, mounted on the top of a golf cart;

FIG. 5 is an environmental view of an embodiment of a vehicle lighting system of the present invention, custom mounted in the trunk lid and header panel of a classic car;

FIG. 6 is an environmental view of an embodiment of a vehicle lighting system of the present invention, mounted on the side mirrors of a car;

FIG. 7 is an environmental view of an embodiment of a vehicle lighting system of the present invention, mounted on the front bumper of a car;

FIG. 8 is an environmental view of an embodiment of a vehicle lighting system of the present invention, mounted on the saddle bags and sissy bar of a motor cycle;

FIG. 9 is an environmental view of an embodiment of a vehicle lighting system of the present invention, mounted on the front fenders, sun visor and sides of a semi-truck;

FIG. 10 is an environmental view of an embodiment of a vehicle lighting system of the present invention, mounted on an arch mounted in the bed of a pickup truck;

FIG. 11 is an environmental view of an embodiment of a vehicle lighting system of the present invention, mounted on a visor mounted on the cab of a pickup truck;

FIG. 12 is an environmental view of an embodiment of a vehicle lighting system of the present invention, mounted in the tailgate of a pick-up truck;

FIG. 13 is an environmental view of an embodiment of a vehicle lighting system of the present invention, mounted in the rear window of a pick-up truck;

FIG. 14 is an environmental view of an embodiment of a vehicle lighting system of the present invention, mounted on the rear fender and rocker panel of a pick up truck;

FIG. 15 is an environmental view of an embodiment of a vehicle lighting system of the present invention, mounted in the rocker panel of a pick-up truck;

FIG. 16 is a view of a set up of three light kits;

FIG. 17 is an environmental view of an embodiment of a wireless remote controller of the present invention; and

FIG. 18 is an environmental view of another embodiment of a wireless remote controller of the present invention.

It should be understood that the above-attached figures are not intended to limit the scope of the present invention in any way.

### DETAILED DESCRIPTION OF THE INVENTION

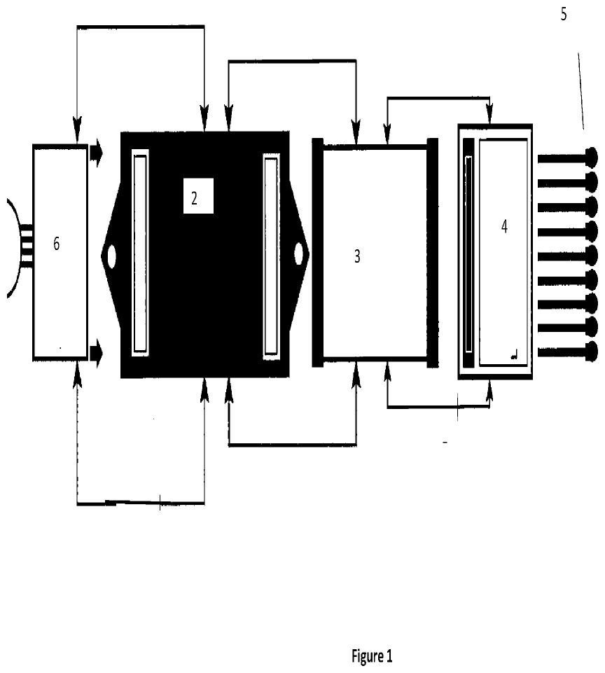

The present invention is an LED lighting system comprising an LED lighting controller and a plurality of LED lights. Referring to FIG. 1 the system comprises an LED Controller 2 which is attached via conductive wires 3 (such as a ribbon cable, USB or HDMI) to a connector board 4 which has outputs to individual LED lamps 5. Power for the controller is provided by a vehicle's existing lighting system via a connector 6.

The controller 2 is microprocessor based and can be programmed to light from zero to 100% of the individual LED lamps 5. Depending on the number of channels built into the controller 2, the LED lamps 5 can be lit singly or in groups. One channel can power a single LED or a single group of LEDs. The controller 2 can control the order in which LED lamps 5 are lit and the duration in which the lamps are lit. In some embodiments, the controller 2 can control the brightness of the LED lamps 5.

If multicolored LED lights are used the controller 2 can also be used to control the color of the LED lights 5. More than one row of LEDs can be incorporated into a light kit.

In some embodiments, the controller is connected to a light kit 7. Light kits can be ready made or custom made for a particular function or vehicle. For example, a light kit can be made to replace the existing original vehicle lights and incorporate turn, stop and tail light functions. A light kit 7 can be made to place lights in new locations on a vehicle. Light kits 7 can include just the LED lamps 6 and wires or can include housings 9 and mounts 10 for the lights. In certain instances, the light kit will include the controller 2 and all mounts 10, wiring and accessories to attach and wire the kit.

The LED lamps 5 or light kits 7 can be located in the rear, front, sides, top or bottom of the vehicle. They can be positioned to serve as brake lights 11, side marker lights 12 or tail lights 13, turn signals 14 or mirror lamps 20. Lights in the rear of the vehicle can be mounted in rear spoilers 15, rear window 16, trunk lid 17, tailgate 18, front bumper 19, rear bumper 21, saddle bags 22, running boards 23 roof racks, trailer hitch mounts, or anywhere on back area of cars, trucks and all vehicles requiring signals. Other areas of applications are sun visors 24, cab fairings 25, wheel flares/fenders 26, door edges, and any other area of a vehicle requiring signals or light.

Upon receiving a signal from the vehicles wiring harness, the controller 2 lights the LED lamps in a pre-programmed fashion. Most commonly in a brake light application the programming will sequentially light lamps starting by lighting lamps 6 in the middle of the vehicle and proceed to light in sequences towards the outside side edge of the vehicle. Such lighting pattern is useful in both turn signals and with brake lights. LED lamps placed as side marker lights 12 and/or mirror lamps 20 can be incorporated toflash with turn signals 14.

Once an LED lamp 5 in an LED strip is lit, it can either be turned off or remain on until the entire LED light strip is lit. Lights can be programed to flash or remain steady. Programs can also randomly light up lights on the strip.

Referring to FIG. 1, power is supplied from the vehicles existing wiring harness via connectors 6 that can tap into individual wires, connect to a trailer wiring harness or tie into a vehicles existing connection points. As will be apparent to one of skill in the art, the existing vehicle lights can be optionally disconnected letting the present invention take over the function or left in place so that the present invention operates as additional lights.

The system of the present invention can be used as single units or in multiple units, such as in pairs for the front and/or back of a vehicle. The controllers when used inpairs can have the same or different programming.

In one embodiment, the controller 2 plugs into an existing trailer type wiring harness for brake, turn and tail lights using a suitable plug. In another embodiment thecontroller is wired to a conventional vehicle harness by splicing as follows:

(B) GREEN--RIGHT turn, (C) YELLOW--LEFT turn, (D) BROWN--STOP-4 WAY, (E) WHITE--GROUND.

In this embodiment the (B),(C),(D),(E) wires are connected with a harness connector plug to the controller 2 the wires from the harness send power to the controller 2 and then the power is sent to the cable 3 which powers any connected LED bulbs or the cable can be connected to different LED lighting kits 7.

The cable connector is plugged in to the controller 2 for any custom installation that can be adapted to any new vehicle on the market today.

In one embodiment the lighting system has at least 4 functions.

Function 1. A left turn signal vehicle command lights the left turn light which then in tandem with vehicle, lights the left LED light kit. The LED light kit lights from the center of the strip and illuminate each light sequentially powered traveling to the left direction, lights appear to travel in the direction left.

Function 2. Right turn signal vehicle command lights right lights and the kit LED lights from the center; each light traveling sequentially in the right direction. Lights appear to travel in the direction right.

Function 3. Vehicle stops light command activates the center LED strip in tandem with vehicle stop lights.

Function 4. Emergency lights- when the vehicle emergency lights are commanded LED strip lights are then illuminated and flash in tandem with the vehicle stop and turn signal lights.

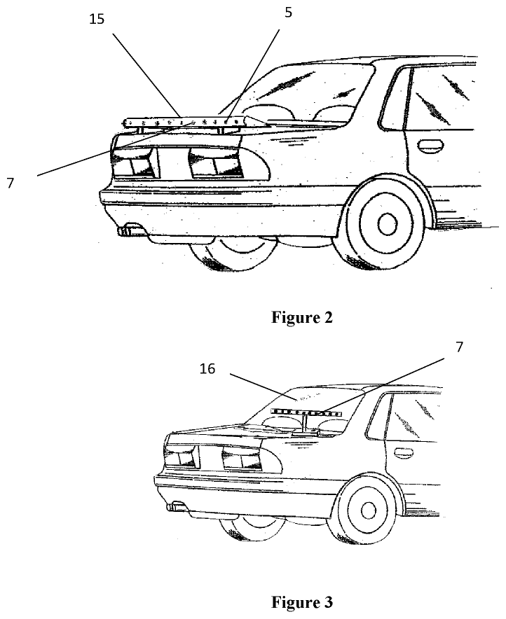

Referring to FIGS. 2-15, the lights of the present invention can be mounted in any suitable location on a vehicle. Such locations include, but are not limited to spoilers, hatches, rear windows, light bars, visors, bumpers, fenders, quarter panels, or rocker panels. The lights can be recessed in the body work or can be surface mounted.

FIG. 2 shows the light kit 7 having LED 5 mounted in a spoiler 16.

FIG. 3 shows the light kit 7 mounted inside a rear window 16. The light kit in some instances may plug directly into an existing third brake light and incorporate its own controller.

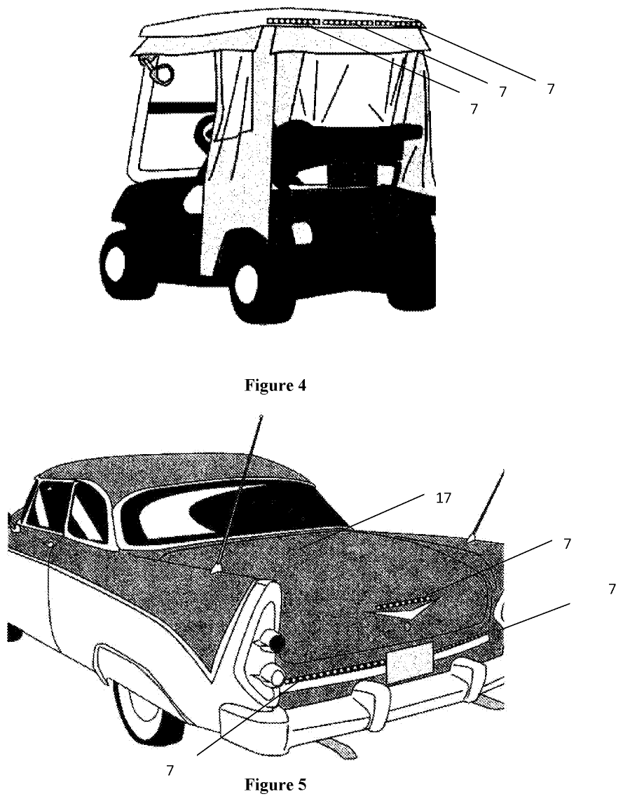

FIG. 4 shows three light kits 7 mounted on the top of a golf cart. The lights can serve as brake lights, turn signals or tail lights.

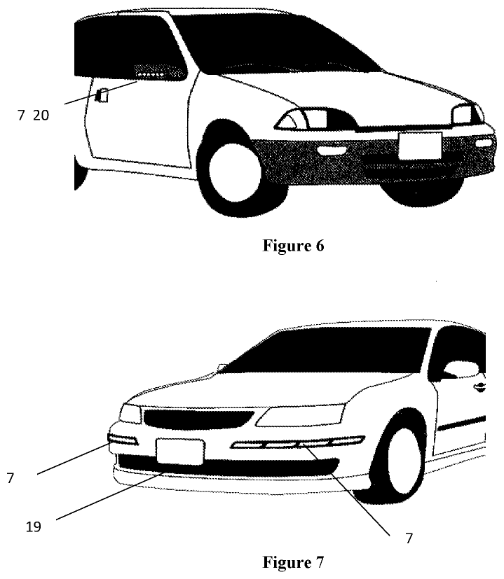

FIG. 5 shows three light kits 7 installed on the trunk 17 of a car. The light kits can serve as brake lights, turn signals or tail lights.

FIG. 6 shows a light kit 7 installed in a mirror 20. In this instance, the light kit would generally be wired as a turn signal. Kits can be installed on both the front and back of the mirror to signal drivers who are in front of or behind the mirror.

FIG. 7 shows two light kits 7 installed on the front bumper 19. In this instance, the light kit would generally be wired as a turn signal. Light kits can be similarly mounted on the rear bumper.

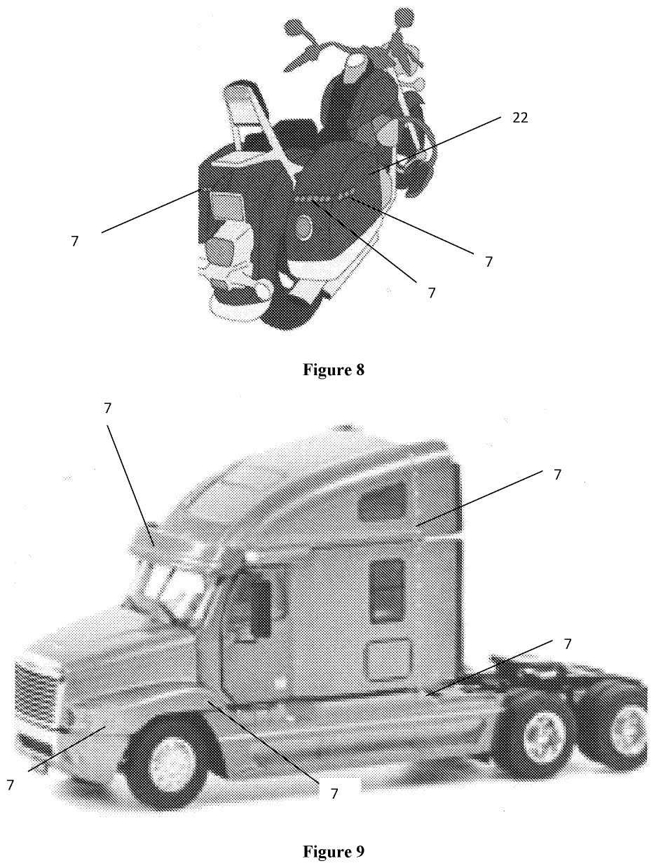

FIG. 8 shows three light kits 7 installed on saddlebags. A fourth light kit on the left side is not shown. These lights could be programmed to be turn signals, brake lights and/or side marker lights.

FIG. 9 shows multiple light kits on a semi cab. Lights are mounted in the running boards, fenders, visors and side of the cab. These lights can serve as turn signals, marker lights and clearance lights.

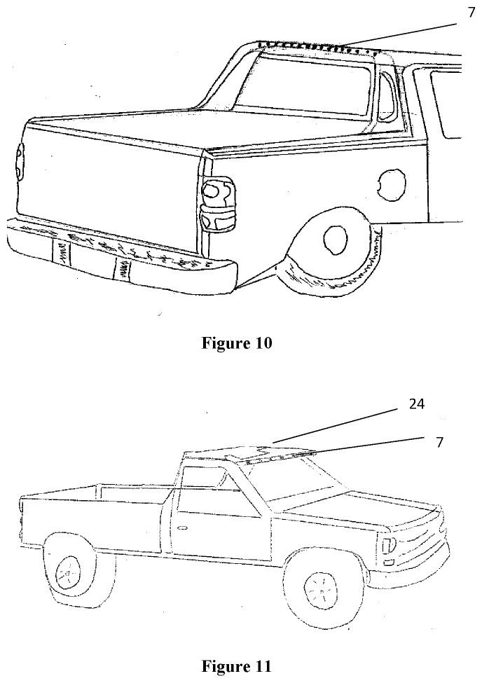

FIG. 10 shows a light kit mounted in the roll bar 7 of a pick up truck. These lights can serve as turn signals and/or brake lights.

FIG. 11 shows light kit 7 installed in the front visor 24. These lights can serve as turn signals, running lights, and or clearance lights.

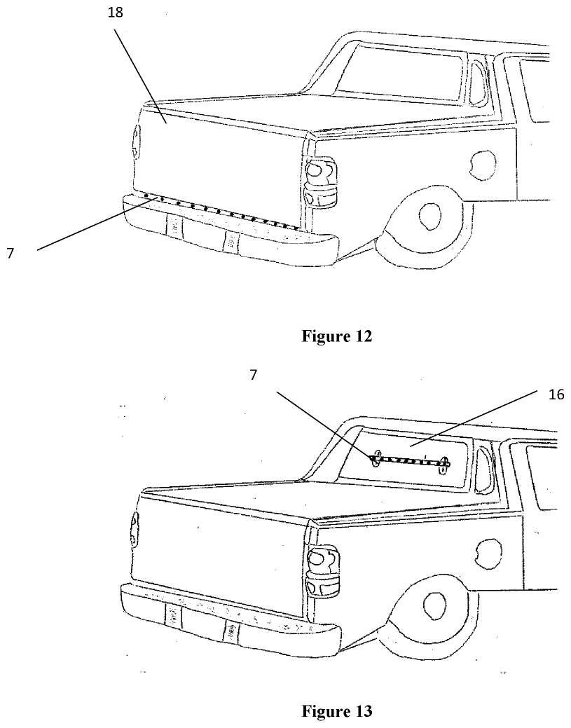

FIG. 12 shows a light kit 7 installed in a tail gate 18. These lights can serve as turn signals and/or brake lights.

FIG. 13 shows a light kit 7 installed in a rear window 16. These lights can serve as turn signals and/or brake lights.

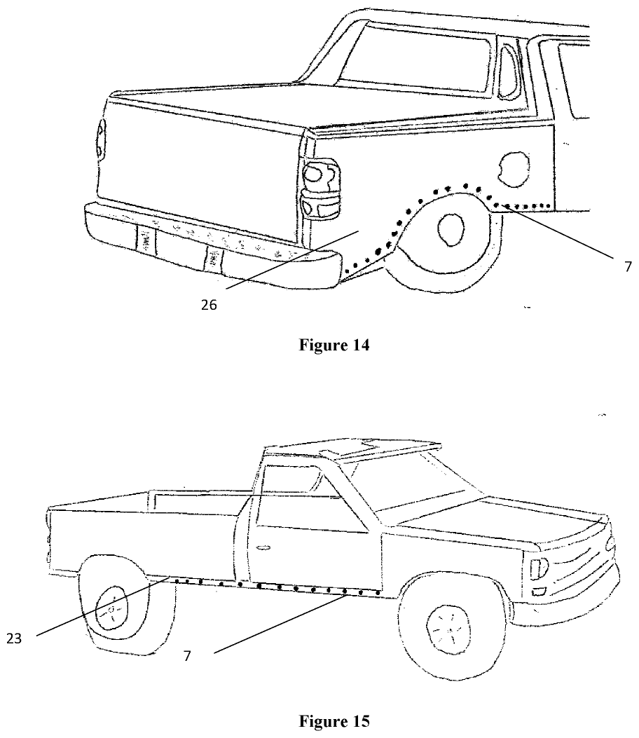

FIG. 14 shows a light kit 7 installed in a fender 26. These lights can serve as turn signals or side marker lights.

FIG. 15 shows a light kit 7 installed in a running board/rocker panel 23. These lights can serve as side marker lights, turn signals and safety lamps when entering or exiting the vehicle.

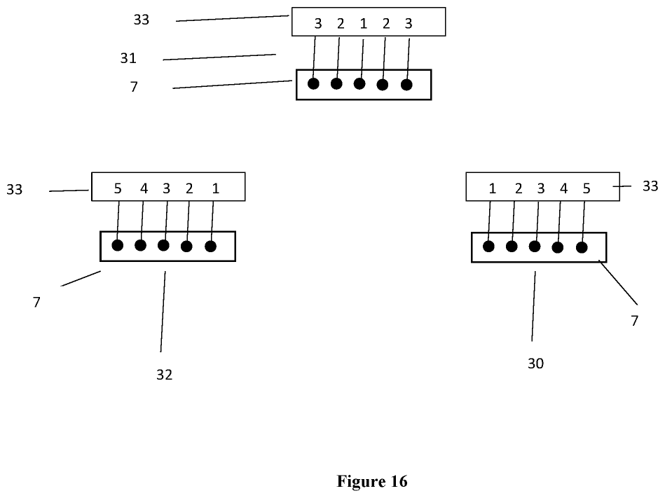

To better show the sequential lighting of brake and turn signals, FIG. 16 shows a set up of three light kits 7 configured as right panel 30, center panel 31 and left panel 32. Sequence indicators 33 show the sequence that LEDs on the panels would typically light. For right panel 30, the LEDs would light up from left to right 1-5. For left panel 32, the LEDs would light up from right to left 1-5. For center panel 31, the LEDs would light from the center 1-3 going right and left. For brake functions all LEDs could be made to light simultaneously and stay lit or flash together or individually.

In some embodiments, the controller incorporates a radio. In this embodiment, multiple lamp kits can have their own module and communicate with each other without the need to run any wires in a vehicle unless a power source is required. One kit would be a master controller connected to the vehicle's electrical system and would communicate with all other kits wirelessly. Protocols for linking multiple wireless transmitters are well known in the art.

In yet another embodiment, the individual light kits have their own power source supplied by at least one battery.

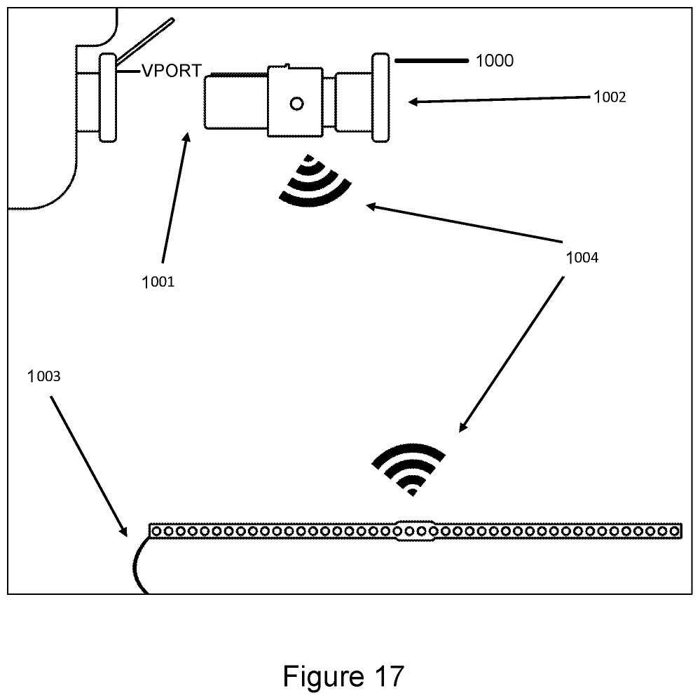

In a further embodiment and as shown in FIG. 17, a 7-pin wireless remote controller 1000, which has software to control light signals, plugs directly into a 7-pin hitch harness port or socket VPORT of a vehicle where it draws power and receives light signals for stopping, hazard (four-way lights), turning, etc. It then in turn will process and communicate these signals to at least one wireless LED strip 1003. The remote controller's plug-in (or male end) 1001 plugs into the 7-pin hitch harness port or socket VPORT while the remote controller's female end 1002 engages with the vehicle's trailer 7-plug (not shown). The 7-pin wireless remote controller 1000 communicates with the at least one wireless LED strip 1003 via wireless communication 1004.

The 7-pin wireless remote controller 1000 has passthrough capabilities so that rear lights on a trailer that utilizes a 7-pin harness plug can still function normally. The 7-pin wireless remote controller 1000 will pass the light signals and power for the lights to the trailer from the vehicle, while still drawing enough power to power itself.

The at least one wireless LED strip 1003 still requires a power source to function. This can be accomplished in multiple ways including, but not limited to, wiring it directly to a vehicle's wiring harness, powered by batteries, or plugged into the DC 12V (cigarette lighter) port of a vehicle.

The 7-pin wireless remote controller 1000 communicates the light signals to the at least one wireless LED strip 1003 wirelessly, preferably over a certain Ghz spectrum that is known to one of ordinary skill in the art. This allows the at least one wireless LED strip 1003 to be placed in the best possible position without being limited with having to be directly connected to the 7-pin wireless remote controller 1000. This also enables the 7-pin wireless remote controller 1000 to control multiple wireless LED strips at the same time.

As a non-limiting example, the 7-pin wireless remote controller 1000 may be implemented with some or all of the corresponding other components of any of the lighting systems of the present invention.

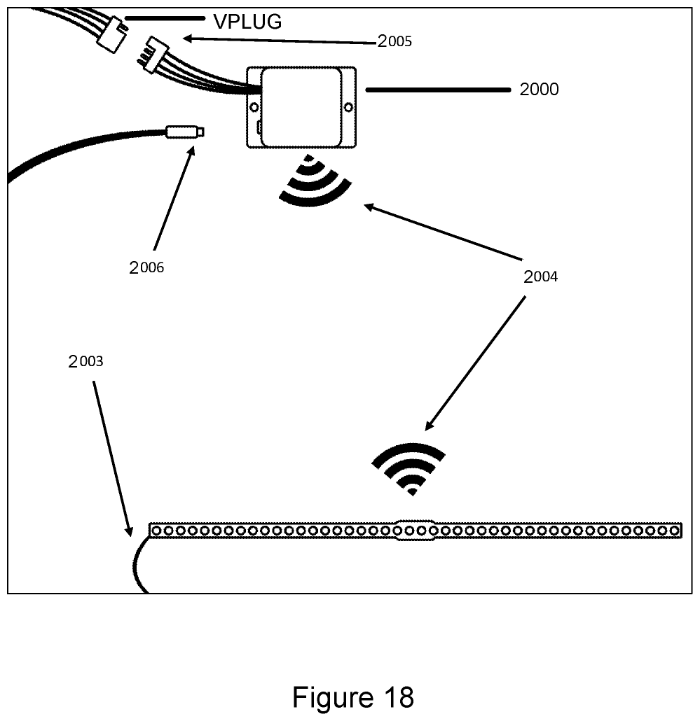

In another embodiment and as shown in FIG. 18, a 4-pin wireless remote controller 2000, which has software to control light signals, can connect directly to a vehicle's 4-pin harness plug, if equipped, or spliced directly into the vehicle's wire harness if it is not equipped with a 4-pin plug. The green wire is for the right signal, yellow wire is for left signal, brown wire for stop, and white wire for ground. The 4-Pin wireless remote controller 2000 will process these light signals and communicate them to at least one wireless LED strip 2003. The remote controller's plug-in 2005 engages with the vehicle's 4-pin harness plug VPLUG. The 4-pin wireless remote controller 2000 communicates with the at least one wireless LED strip 2003 via wireless communication 2004. As a non-limiting example, the extra power connector 2006 provides additional power to the at least one wireless LED strip 2003 via the 4-pin wireless remote controller 2000.

In addition to the four wires for the signal, the 4-pin wireless remote controller 2000 needs a power source with ground. This can come from slicing into the vehicle's wiring harness or battery terminals.

As a non-limiting example, the 4-pin wireless remote controller 2000 may be implemented with some or all of the corresponding other components of any of the lighting systems of the present invention.

One of skill in the art will appreciate that the invention is not limited to the specific embodiments disclosed herein and that the invention can readily be modified to the needs of a particular vehicle customize the order in which LEDs are lit.

1. An accessory vehicle lighting system for providing signaling assistance to a vehicle's signaling system, said lighting system comprising:
a 7-pin wireless remote controller for connecting to a signaling system of a vehicle for coordination with regard to light signals for stop, right turn, left turn and emergency functions,
wherein said 7-pin wireless remote controller comprises a first end, a second end, and software to control the light signals, and wherein said first end of said 7-pin wireless remote controller is adapted for being plugged into a 7-pin hitch harness port or socket of the vehicle where it receives the light signals while said second end of said 7-pin wireless remote controller is adapted for engaging with a 7-plug of the vehicle; and
at least one wireless LED strip for receiving communications regarding the light signals from said 7-pin wireless remote controller, wherein said at least one wireless LED strip is secured to at least one vehicle location,
wherein said at least one wireless LED strip comprises a plurality of lighting elements that are controlled by said 7-pin wireless remote controller and that are viewable by others outside the vehicle during use so as to provide signaling assistance to the vehicle's signaling system,
wherein, during use, said plurality of lighting elements are activated and provide lighted signals at specific instances to assist the vehicle's signaling system, and
wherein said lighted signals produced by said plurality of lighting elements are separate from lighted signals produced by the vehicle's signaling system.

2. The accessory vehicle lighting system of claim 1, wherein at least one lighted signal of said lighted signals produced by said plurality of lighting elements is a sequential, lighted signal.

3. The accessory vehicle lighting system of claim 1, wherein said at least one wireless LED strip is detachably secured to the at least one vehicle location by tape.

4. The accessory vehicle lighting system of claim 1, wherein a plurality of lighting elements of said plurality of lighting elements are embedded within at least one light strip of said at least one wireless LED strip.

5. The accessory vehicle lighting system of claim 1, wherein said 7-pin wireless remote controller has passthrough capabilities so that rear lights on a trailer that utilizes a 7-pin harness plug can still function normally.

6. The accessory vehicle lighting system of claim 1, wherein said at least one wireless LED strip is wired directly to a vehicle's wiring harness, powered by batteries, or plugged into a DC 12V port of the vehicle.

7. An accessory vehicle lighting system for providing signaling assistance to a vehicle's signaling system, said lighting system comprising:
a 4-pin wireless remote controller for connecting to a signaling system of a vehicle for coordination with regard to light signals for stop, right turn, left turn and emergency functions,
wherein said 4-pin wireless remote controller comprises a first end and software to control the light signals, and
wherein said first end of said 4-pin wireless remote controller is adapted for being plugged into a 4-pin harness plug of the vehicle, if equipped, or spliced directly into the wire harness of the vehicle where it receives the light signals; and
at least one wireless LED strip for receiving communications regarding the light signals from said 4-pin wireless remote controller,
wherein said at least one wireless LED strip is secured to at least one vehicle location,
wherein said at least one wireless LED strip comprises a plurality of lighting elements that are controlled by said 4-pin wireless remote controller and that are viewable by others outside the vehicle during use so as to provide signaling assistance to the vehicle's signaling system,
wherein, during use, said plurality of lighting elements are activated and provide lighted signals at specific instances to assist the vehicle's signaling system, and
wherein said lighted signals produced by said plurality of lighting elements are separate from lighted signals produced by the vehicle's signaling system.

8. The accessory vehicle lighting system of claim 7, wherein at least one lighted signal of said lighted signals produced by said plurality of lighting elements is a sequential, lighted signal.

9. The accessory vehicle lighting system of claim 7, wherein said at least one wireless LED strip is detachably secured to the at least one vehicle location by tape.

10. The accessory vehicle lighting system of claim 7, wherein a plurality of lighting elements of said plurality of lighting elements are embedded within at least one light strip of said at least one wireless LED strip.

11. The accessory vehicle lighting system of claim 7, wherein said 4-pin wireless remote controller has passthrough capabilities so that rear lights on a trailer that utilizes a 4-pin harness plug can still function normally.

12. The accessory vehicle lighting system of claim 7, wherein said at least one wireless LED strip is wired directly to a vehicle's wiring harness, powered by batteries, or plugged into a DC 12V port of the vehicle.

13. The accessory vehicle lighting system of claim 7, further comprising an extra power connector providing additional power to said at least one wireless LED strip via said 4-pin wireless remote controller.
